(19) United States
(12) Patent Application Publication
(10) Pub. No.: US 2025/0207001 A1
(43) Pub. Date: Jun. 26, 2025

(54) Method of underwater bonding

(71) Applicant: Henkel AG & Co. KGaA, Duesseldorf (DE)

(72) Inventors: Gavin Haberlin, Naas (IE); Emer Ward, Saggart (IE); Michael Jordan, Ballycullen (IE); Susan Reilly, Clane (IE)

(21) Appl. No.: 18/985,848

(22) Filed: Dec. 18, 2024

Related U.S. Application Data
(63) Continuation of application No. PCT/EP2023/067484, filed on Jun. 27, 2023.

(30) Foreign Application Priority Data
Jun. 28, 2022 (GB) 2209486.6
Dec. 9, 2022 (GB) 2218579.7

(51) Int. Cl. C09J 133/20; C09J 137/00; C09J 141/00; C09J 163/00

(52) U.S. Cl. CPC C09J 133/20; C09J 137/00; C09J 141/00; C09J 163/00; C09J 2463/00; C09J 2481/00

(57) ABSTRACT

A method of bonding substrates that are underwater comprising applying, underwater, a cyanoacrylate composition to at least one substrate and allowing the composition to cure underwater.

### FIELD

The present invention provides a method of underwater bonding by curable cyanoacrylate compositions.

### BRIEF DESCRIPTION OF RELATED TECHNOLOGY

Curable compositions such as cyanoacrylate adhesives are well recognized for their excellent ability to rapidly bond a wide range of substrates, generally in a number of minutes and depending on the particular substrate, often in a number of seconds.

Cyanoacrylate adhesive compositions are well known, and widely used as quick setting, instant adhesives with a wide variety of uses. See H. V. Coover, D. W. Dreifus and J. T. O'Connor, “Cyanoacrylate Adhesives” in Handbook of Adhesives, 27, 463-77, I. Skeist, ed., Van Nostrand Reinhold, New York, 3rd ed. (1990). See also G. H. Millet, “Cyanoacrylate Adhesives” in Structural Adhesives: Chemistry and Technology, S. R. Hartshorn, ed., Plenum Press, New York, p. 249-307 (1986).

Cyanoacrylates adhesive compositions are well suited to curing in air. Beneficially these compositions achieve handling strength in seconds when cured in air and >60% strength within 1 minute when cured in air.

Polymerization of cyanoacrylates is initiated by nucleophiles found under normal atmospheric conditions on most surfaces. The initiation by surface chemistry means that sufficient initiating species are available when two surfaces are in close contact with a small layer of cyanoacrylate between the two surfaces. Under these conditions a strong bond is obtained in a short period of time. Thus, in essence the cyanoacrylate often functions as an instant adhesive.

Cyanoacrylate adhesive compositions are not traditionally used for underwater applications because cyanoacrylate adhesive compositions are difficult to dispense underwater. It will be appreciated that underwater means that the substrates to be bonded are completely submerged in water. The water is in contact with the substrates. Underwater as used herein does not refer to a situation where the substrates are underwater but not in contact with the water, for example underwater does not refer to substrates which are placed in a waterproof container and this container is in contact with water while the substrate are not in contact with water as the waterproof container keeps them dry. In particular the present invention is concerned with methods employing cyanoacrylate adhesive which is dispensed from a container while underwater. In such cases the cyanoacrylate adhesive is dispensed through the water onto a substrate surface and that substrate surface is also in contact with water.

Dispensing cyanoacrylate adhesive compositions underwater causes the composition to react with the water and the compositions may prematurely cure prior to being applied to the substrates it is intended to bond. Indeed, cyanoacrylate compositions are well known to be sensitive to water and in some cases even trace amounts of water can cause premature cure for example during storage for later use.

Cyanoacrylate adhesive performance, particularly durability, oftentimes becomes suspect when exposed to water. A bond formed using cured cyanoacrylate compositions can be susceptible to water. For example, the bond formed may ultimately fail due to degradation of the cured cyanoacrylate composition over time when exposed to water. In general exposure to water causes loss of bond strength over time.

Cyanoacrylate adhesive compositions when dispensed underwater may also partially cure when it is applied to a first substrate but prior to joining to a second substrate. While it may be possible in this case to form a bond between the substrates the bond will be weak as the composition has partially part cured before the substrates are jointed.

To overcome these issues typically cyanoacrylate adhesive compositions may be applied to substrates in air and then the bonded substrates are placed underwater.

Underwater bonding using cyanoacrylate adhesive compositions would be advantageous for applications where the properties of cyanoacrylate adhesive compositions would be beneficial. In situations where it is difficult to remove the substrates from water it would be beneficial to both dispense and to cure a cyanoacrylate adhesive composition underwater. For example, when performing boat repairs or maintenance or fitting new parts, such as sensors, to boats it would be beneficial to use a cyanoacrylate adhesive composition for bonding parts of the boat which are underwater to eliminate the need to remove the boat from the water, which can be challenging and expensive and requires the ship to return to land. Similarly, it would be useful to be able to perform underwater maintenance and repairs or to fit parts to structures which are wholly or partially underwater, such as oil rig apparatus, bridges, pipelines, etc.

Coral reefs are formed by colonies of coral polyps. The skeletons of the coral polyps are formed from calcium carbonate and the coral polyps are held together by their calcium carbonate skeletons. The majority of coral reefs are built by stony corals polyps also called Scleractinia. Stony corals secrete hard calcium carbonate exoskeletons which protect and support the coral reef. Coral reefs can be damaged by, for example excess nutrients or oceanic acidification. Coral transplantation is considered a viable method of assisting coral reefs to recover from damage. Healthy coral polyps are transplanted from healthy reefs to damaged reefs. Healthy polyps may assist in repair of the coral reef. The transplanted coral polyps are secured to their new location using cement or epoxy. If the transplanted coral polyps detach from where they have been transplanted to the coral polyps will die and the transplantation is not successful. In these methods the dispensing, applying, and curing of the epoxy can take a long time. This means that the user, often a diver, must spend extended periods of time underwater, which is expensive and can be dangerous.

Dizon et al compared the use of a cyanoacrylate adhesive gel composition, an epoxy putty, and a marine epoxy to determine their suitability for attachment of coral polyps. Dizon et al applied the cyanoacrylate adhesive composition above water and subsequently submerged the coral polyp underwater. Dizon et al found that while the cyanoacrylate adhesive compositions were the easiest to handle they rated poorly in the critical areas of effectiveness of attachment and transplant self-attachment.

It would be beneficial to provide an adhesive composition which has the benefits of a cyanoacrylate composition and is effective in attaching coral polyps during transplantation.

It would be beneficial to provide alternative adhesives which can: (1) be dispensed while submerged, (2) remain uncured for sufficient time to allow application to a substrate to be bonded; (3) subsequently cure, desirably with a short cure time (4) develop high strength bonds, and (5) retain bond strength. All of the foregoing need to be achieved underwater.

### SUMMARY

In one aspect, the present invention provides a method of bonding substrates that are underwater comprising:
applying, underwater, a cyanoacrylate composition to at least one substrate, wherein the cyanoacrylate composition comprises a first part comprising:
   a cyanoacrylate component and a cationic catalyst;
and a second part comprising:
   a cationically curable component, such as an epoxy component, an episulfide component, an oxetane component, and combinations thereof, and an initiator component,
and allowing the composition to cure underwater.

Underwater means that the substrates are submerged in water so that the water is in contact with the substrates at the same time as the composition is applied. The substrates are not, for example, in a water proof container so that they are not directly exposed to the water. Beneficially the method allows bonding underwater in applications traditionally excluded due to an inability to remove and dry the assembly before bonding.

Beneficially the composition applied in the method can be dispensed while submerged, remains uncured for sufficient time to allow application to a substrate to be bonded; and subsequently cures with a short cure time. Beneficially the cured composition which was allowed to cure underwater develops high strength bonds and retains that bond strength over time. Desirably the composition has a sufficiently long open time so that it can be dispensed, applied, and the substrate(s) bonded before the composition cures, but a faster cure time than compositions used in previous methods in order to minimise the time that the user must spend underwater.

The perceived shortcomings of cyanoacrylate compositions for bonding substrates that are underwater may be overcome with the cyanoacrylate hybrid composition disclosed herein. All of the desirable properties of the present invention refer to those properties of the composition in an underwater environment. Compositions of the invention remain in place when dispensed. Compositions of the method can be dispensed underwater, for example there is no premature cure upon first contact with water which would prevent dispensing of the composition onto a substrate. It is possible a skin may form where there is initial contact with water but there is no cure through the volume of the composition that would prevent dispensing. Compositions of the method may have a suitable viscosity to allow them to be dispensed. The compositions may have a suitable buoyancy. For example, it is appropriate that a composition of the method is not moved out of position by the forces caused by normal water currents.

The composition may be dispensed underwater and used in a method of bonding substrates that are underwater. While not wishing to be bound by a theory it is thought that, a combination of cure speed modulation due to the epoxy portion of the hybrid and the material's inherent high viscosity, may impart this unexpected open time in an aqueous environment. The first part of the composition may have a cone and plate viscosity of from 4000 to 7000 mPa·s. The second part may have a viscosity of from 25000 to 40000 mPa·s. Both viscosities are as measured according to ASTM D7867.

In addition, the cationically curable component may initiate cure of the cyanoacrylate.

The cyanoacrylate component of the cyanoacrylate composition applied in the method may be selected from materials within the structure H₂C═C(CN)—COOR, wherein R is selected from C₁₋₁₅ alkyl, C₂₋₁₅ alkoxyalkyl, C₃₋₁₅ cycloalkyl, C₂₋₁₅ alkenyl, C₆₋₁₅ aralkyl, C₅₋₁₅ aryl, C₃₋₁₅ allyl and C₁₋₁₅ haloalkyl groups, for example wherein the cyanoacrylate component comprises ethyl-2-cyanoacrylate (“ECA”).

The cyanoacrylate component should be included in the Part A composition in an amount within the range of from about 50% to about 99.98% by weight, such as about 65% to about 85% by weight being desirable, and about 75% to about 97% by weight of the total composition being particularly desirable.

As the cationic catalyst to be included in the Part A composition of the two-part adhesive system, a hard cation non-nucleophilic anion catalyst should be used. Examples of such catalysts include salts of lithium and metals from Group II of the Periodic Table, and non-nucleophilic acids. Such non-nucleophilic acids have a pH of less than 1.0 when measured as a 10% by weight solution in water and the anion portion of such acids does readily participate in displacement reactions with organic halides. Examples of the Group II metal salts include calcium and magnesium. Examples of non-nucleophilic acids include perchloric, fluoroboric, fluoroarsenic, fluoroantimonic and fluorophosphoric acids. Accordingly, examples of hard cation non-nucleophilic anion salts include lithium tetrafluoroborate, calcium di-tetrafluoroborate, magnesium di-tetrafluoroborate, lithium hexafluorophosphate, calcium di-hexafluorophosphate, magnesium di-hexafluorophosphate, lithium hexafluoroantimonate and lithium hexafluoroarsenate.

The cationic catalyst may also include lanthanide triflate salts, aryl iodonium salts, aryl sulfonium salts, lanthanum triflate, ytterbium triflate, trimethoxyboroxine, trimethoxyboroxine-aluminum acetyl acetonate, amine-boron trihalide complexes, quaternary ammonium salts, quaternary phosphonium salts, tri-aryl sulfonium salts, di-aryl iodonium salts, and diazonium salts.

Another cationic catalyst suitable for use herein in the Part A composition of the adhesive system are trialkoxyboroxine curing agents, such as are described in U.S. Pat. Nos. 4,336,367 and 6, 617, 400, the disclosures of each of which are hereby incorporated herein by reference. Of course, combinations of any two or more of these cationic catalysts may be used as well.

Also suitable for use as some or all of the cationic catalyst are boron triflouride, boron trifluoride-etherate, sulphur trioxide (and hydrolysis products thereof) and methane sulfonic acid, which are oftentimes used to stabilize cyanoacrylate monomers against anionic polymerization (see below), a known issue in shelf life stabilization.

Typically, the amount of cationic catalyst will fall in the range of about 0.001 weight percent up to about 10.00 weight percent of the composition, desirably about 0.01 weight percent up to about 5.00 weight percent of the composition, such as about 0.50 to 2.50 weight percent of the composition.

Additives may be included in the Part A composition of the adhesive system to confer physical properties, such as improved fixture speed, improved shelf-life stability, flexibility, thixotropy, increased viscosity, color, and improved toughness. Such additives therefore may be selected from accelerators, free radical stabilizers, anionic stabilizers, gelling agents, thickeners [such as PMMAs], thixotropy conferring agents (such as fumed silica), dyes (such as carbon black), toughening agents, plasticizers and combinations thereof.

These additives are discussed in more detail below. However, the accelerators and stabilizers are discussed here.

One or more accelerators may also be used in the adhesive system, particularly, in the Part A composition, to accelerate cure of the cyanoacrylate component. Such accelerators may be selected from calixarenes and oxacalixarenes, silacrowns, crown ethers, cyclodextrins, poly(ethyleneglycol) di(meth)acrylates, ethoxylated hydric compounds and combinations thereof.

Of the calixarenes and oxacalixarenes, many are known, and are reported in the patent literature. See e.g. U.S. Pat. Nos. 4,556,700, 4,622,414, 4, 636, 539, 4, 695, 615, 4,718,966, and 4,855,461, the disclosures of each of which are hereby expressly incorporated herein by reference.

For instance, as regards calixarenes, those within the structure below are useful herein:

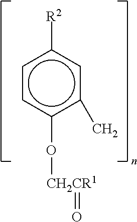

where R¹ is alkyl, alkoxy, substituted alkyl or substituted alkoxy; R² is H or alkyl; and n is 4, 6 or 8.

One particularly desirable calixarene is tetrabutyl tetra[2-ethoxy-2-oxoethoxy]calix-4-arene.

A host of crown ethers are known. For instance, examples which may be used herein either individually or in combination include 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5, 3,4,5-naphtyl-16-crown-5, 1,2-methyl-benzo-18-crown-6, 1,2-methylbenzo-5, 6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6 and 1,2-benzo-1,4-benzo-5-oxygen-20-crown-7. See U.S. Pat. No. 4,837,260 (Sato), the disclosure of which is hereby expressly incorporated here by reference.

Of the silacrowns, again many are known, and are reported in the literature. For instance, a typical silacrown may be represented within the structure below:

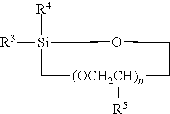

where R³ and R⁴ are organo groups which do not themselves cause polymerization of the cyanoacrylate monomer, R⁵ is H or CH₃ and n is an integer of between 1 and 4. Examples of suitable R³ and R⁴ groups are R groups, alkoxy groups, such as methoxy, and aryloxy groups, such as phenoxy. The R³ and R⁴ groups may contain halogen or other substituents, an example being trifluoropropyl. However, groups not suitable as R⁴ and R⁵ groups are basic groups, such as amino, substituted amino and alkylamino.

Specific examples of silacrown compounds useful in the inventive compositions include:

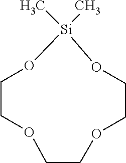

dimethylsila-11-crown-4;

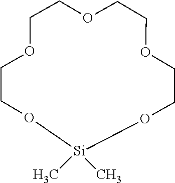 [SMILES: C[Si]1(C)OCCOCCOCCOCCO1]

dimethylsila-14-crown-5;

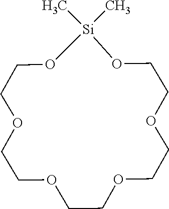 [SMILES: C[Si]1(C)OCCOCCOCCOCCOCCO1]

and dimethylsila-17-crown-6. See e.g. U.S. Pat. No. 4,906,317 (Liu), the disclosure of which is hereby expressly incorporated herein by reference.

Many cyclodextrins may be used in connection with the present invention. For instance, those described and claimed in U.S. Pat. No. 5,312,864 (Wenz), the disclosure of which is hereby expressly incorporated herein by reference, as hydroxyl group derivatives of an α, β or γ-cyclodextrin which is at least partly soluble in the cyanoacrylate would be appropriate choices for use herein as an accelerator component.

In addition, poly(ethylene glycol) di(meth)acrylates suitable for use herein include those within the structure below:

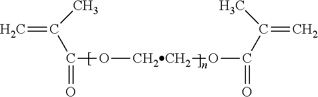

where n is greater than 3, such as within the range of 3 to 12, with n being 9 as particularly desirable. More specific examples include PEG 200 DMA, (where n is about 4) PEG 400 DMA (where n is about 9), PEG 600 DMA (where n is about 14), and PEG 800 DMA (where n is about 19), where the number (e.g., 400) represents the average molecular weight of the glycol portion of the molecule, excluding the two methacrylate groups, expressed as grams/mole (i.e., 400 g/mol). A particularly desirable PEG DMA is PEG 400 DMA.

And of the ethoxylated hydric compounds (or ethoxylated fatty alcohols that may be employed), appropriate ones may be chosen from those within the structure below:

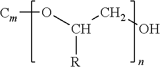

where Cₘ can be a linear or branched alkyl or alkenyl chain, m is an integer between 1 to 30, such as from 5 to 20, n is an integer between 2 to 30, such as from 5 to 15, and R may be H or alkyl, such as C₁₋₆ alkyl.

Commercially available examples of such materials include those offered under the DEHYDOL tradename from Cognis Deutschland Gmbh & Co. KGaA, Dusseldorf, Germany, such as DEHYDOL 100.

In addition, accelerators embraced within the structure below:

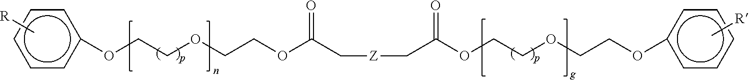

where R is hydrogen, C₁₋₆ alkyl, C₁₋₆ alkyloxy, alkyl thioethers, haloalkyl, carboxylic acid and esters thereof, sulfinic, sulfonic and sulfurous acids and esters, phosphinic, phosphonic and phosphorous acids and esters thereof, Z is a polyether linkage, n is 1-12 and p is 1-3 are as defined above, and R′ is the same as R, and g is the same as n.

A particularly desirable chemical within this class as an accelerator component is

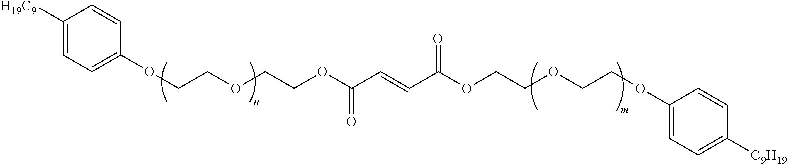

where n and m combined are greater than or equal to 12.

The accelerator should be included in the composition in an amount within the range of from about 0.01% to about 10% by weight, with the range of about 0.1 to about 0.5% by weight being desirable, and about 0.4% by weight of the total composition being particularly desirable.

Stabilizers useful in the Part A composition of the adhesive system include free-radical stabilizers, anionic stabilizers and stabilizer packages that include combinations thereof. The identity and amount of such stabilizers are well known to those of ordinary skill in the art. See e.g. U.S. Pat. Nos. 5,530,037 and 6,607,632, the disclosures of each of which are hereby incorporated herein by reference. Commonly used free-radical stabilizers include hydroquinone, while commonly used anionic stabilizers include boron triflouride, boron trifluoride-etherate, sulphur trioxide (and hydrolysis products thereof) and methane sulfonic acid. These anionic stabilizers can also serve as the cationic catalyst or a portion thereof, as noted above.

### Part B

Cationically curable monomers for use in the Part B composition of the adhesive system include epoxy monomers, episulfide monomers, oxetane monomers, and combinations thereof.

Epoxy monomers for use in Part B of the composition of the adhesive system include a host of epoxy monomers, with some of the epoxy monomers being aromatic, while others are aliphatic and still others are cycloaliphatic. Examples of such epoxy monomers include bisphenol F diglycidyl ethers (and hydrogenated versions thereof), bisphenol A diglycidyl ethers (and hydrogenated versions thereof), bisphenol S diglycidyl ethers (and hydrogenated versions thereof), bisphenol E diglycidyl ethers (and hydrogenated versions thereof), biphenyl diglycidyl ethers (and hydrogenated versions thereof), 4-vinyl-1-cyclohexene diepoxide, butanediol diglycidyl ether, neopentylglycol diglycidyl ether, 3,4-epoxycyclohexylmethyl-3,4-epoxycyclohexanecarboxylate, limonene diepoxide, α-pinene oxide, hexanediol diglycidyl ether, trimethylolpropane triglycidyl ether, aniline diglycidyl ether, diglycidyl ether of propylene glycol, cyanuric acid triglycidyl ether, ortho-phthalic acid diglycidyl ether, diglycidyl ester of linoleic dimer acid, dicyclopentadiene diepoxide, tetrachlorobisphenol A glycidyl ethers, 1,1,1-tris(p-hydroxyphenyl) ethane glycidyl ether, tetra glycidyl ether of tetrakis(4-hydroxyphenyl) ethane, epoxy phenol novolac resins, epoxy cresol novolac resins, tetraglycidyl-4,4′-diaminodiphenylmethane, and the like.

Among the commercially available epoxy resins suitable for use are polyglycidyl derivatives of phenolic compounds, such as those available under the tradenames EPON 828, EPON 1001, EPON 1009, and EPON 1031, from Shell Chemical Co.; DER 331, DER 332, DER 334, and DER 542 from Dow Chemical Co.; GY285 from Ciba Specialty Chemicals, Tarrytown, New York; and BREN-S from Nippon Kayaku, Japan; epoxidized polybutadienes, such as those sold under the trade designation PolyBD from Sartomer, EPOLEAD PB 3600 from Daicel, JP-100 and JP-200 from Nippon Soda, epoxidised liquid isoprene rubbers such as KL-610, KL-613 and KL-630T from Kuraray; and epoxidised liquid polyisoprenes such as EPOXYPRENE 25 and EPOXYPRENE 50 from Sanyo Corporation. Other suitable epoxy resins include polyepoxides prepared from polyols and the like and polyglycidyl derivatives of phenol-formaldehyde novolacs, the latter of which are available commercially under the tradenames DEN 431, DEN 438, and DEN 439 from Dow Chemical Company. Cresol analogs are also available commercially ECN 1235, ECN 1273, and ECN 1299 from Ciba Specialty Chemicals. SU-8 is a bisphenol A-type epoxy novolac available from Resolution. Of course, cycloaliphatic epoxy resins, such as those available under the CYRACURE tradename, and hydrogenated bisphenol and biphenyl type epoxy resins, as noted, such as those available under the EPALLOY tradename, are suitable for use herein.

Cycloaliphatic epoxy resins contain at least one cycloaliphatic group and at least one oxirane group, oftentimes two oxirane groups. Representative cycloaliphatic epoxy resins include 2-(3,4-epoxy)cyclohexyl-5,5-spiro-(3,4-epoxy)cyclohexane-m-dioxane, 3,4-epoxycyclohexylmethyl-3,4-epoxycyclohexanecarboxylate, 3,4-epoxy-6-methylcyclohexylmethyl-3,4-epoxy-6-methylcyclohexanecarboxylate, vinyl cyclohexanedioxide, bis(3,4-epoxycyclohexylmethyl) adipate, bis(3,4-epoxy-6-methylcyclohexylmethyl) adipate, exo-exo bis(2,3-epoxycyclopentyl) ether, endo-exo bis(2,3-epoxycyclopentyl) ether, 2,2-bis(4-(2,3-epoxypropoxy)cyclohexyl) propane, 2,6-bis(2,3-epoxypropoxycyclohexyl-p-dioxane), 2,6-bis(2,3-epoxypropoxy) norbornene, the diglycidylether of linoleic acid dimer, limonene dioxide, a-pinene oxide, 3-vinylcyclohexene oxide, 3-vinylcyclohexene dioxide, epoxidised poly(1,3-butadiene-acrylonitrile), epoxidised soybean oil, epoxidised castor oil, epoxidised linseed oil, 2,2-bis(3,4-epoxycyclohexyl) propane, dicyclopentadiene dioxide, tricyclopentadiene dioxide, tetracyclopentadiene dioxide, 1,2-epoxy-6-(2,3-epoxypropoxy) hexahydro-4,7-methanoindane, p-(2,3-epoxy)cyclopentylphenyl-2,3-epoxypropylether, 1-(2,3-epoxypropoxy)phenyl-5,6-epoxyhexahydro-4,7-methanoindane, 0-(2,3-epoxy) cyclopentylphenyl-2,3-epoxypropylether, 1,2-bis[5-(1,2-epoxy)-4,7-hexahydromethanoindanoxyl]ethane, cyclopentenylphenyl glycidyl ether, cyclohexanediol diglycidyl ether, and diglycidyl hexahydrophthalate. Siloxane functional epoxy resins may also be utilised such as 1,3-bis(3,4-epoxycyclohexyl-2-ethyl)-1,1,3,3-tetramethyldisiloxane and other epoxy functional linear/cyclic siloxanes such as those disclosed in U.S. Pat. No. 7,777,064, the disclosure of which being hereby expressly incorporated herein by reference. In particular embodiments cycloaliphatic epoxy resins are 3,4-epoxycyclohexylmethyl-3,4-epoxycyclohexanecarboxylate and 3,4-epox-6-methylcyclohexylmethyl-3,4-epoxy-6-methylcyclohexanecarboxylate. Other examples of cycloaliphatic epoxies suitable for use herein include those disclosed and described in U.S. Pat. No. 6,429,281 (Dershem), the disclosure of which being hereby expressly incorporated herein by reference.

And of course, combinations of the epoxy resins are also desirable for use herein.

The episulfide monomer may simply be the full or partial sulphur-containing three-membered ring version of the base epoxy monomer.

The oxetane monomers may be chosen from

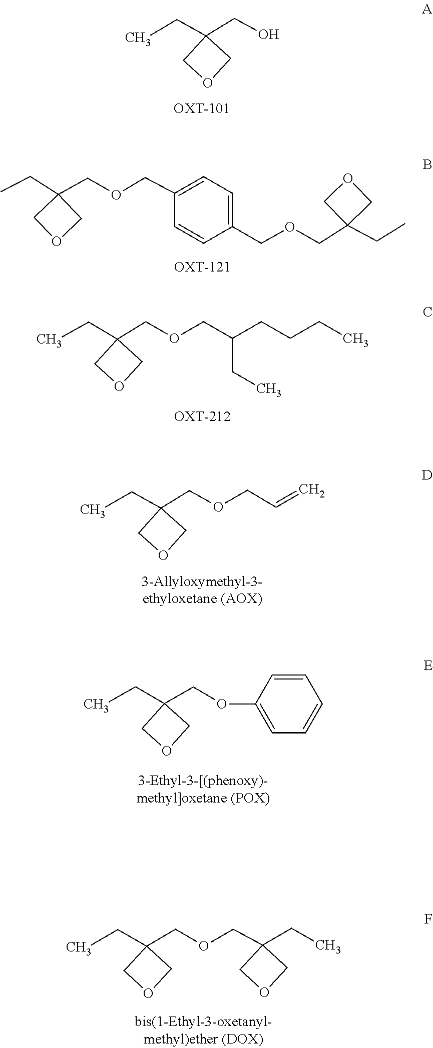

Oxetanes labeled A-C are available from Toa Gosei Co., Ltd., Japan.

Vinyl ethers may also be included. The vinyl ether monomer may be selected from a host of materials, such as those commercially available under the tradename VEctomer from Vertellus Performance Materials Inc., Greensboro, NC. Examples include VEctomer vinyl ether 4010 [Bis-(4-vinyl oxy butyl) isophthalate], VEctomer vinyl ether 4060 [Bis(4-vinyl oxy butyl) adipate], and VEctomer vinyl ether 5015 [Tris(4-vinyloxybutyl)trimellitate].

The epoxy, episulfide, oxetane and/or vinyl ether monomer may be one that is functionalized with one or more alkoxy silane groups. Examples of such materials include those commercially available from Gelest Inc., Morrisville, PA.

As discussed above, additives may be included in either or both of the Part A or the Part B compositions to influence a variety of performance properties.

Additives may be included to improve fixture time in two part cationically curable/epoxy hybrid adhesive systems, including aromatic heterocycles such as pyridines, toluidines, and benzothiazoles, in particular 2-substituted benzothiazoles where the 2-substituent is an alkyl, an alkene, an alkylbenzyl, an alkylamino, an alkoxy, an alkylhydroxy, an ether, a thioalkyl, a thiolalkoxy or a sulphonamide group, with the proviso that an amide portion of the sulphonamide group does not have a tert butylamino or a morpholine group, more specifically, materials such as 3,5-dibromopyridine, 3,5-dichloropyridine, N, N-dimethyl-p-toluidine, 2,2-dipyridyl disulphide, 5-chloro-2-methyl benzothiazole, 2-methyl-mercaptobenzothiazole, N, N-dihydroethyl-p-toluidine and t-butylbenzothiazole sulphonamide. Also, phenolics like 4-methyl-2,2-ditertiarybutylphenol and 4-methoxyphenol may be used.

These additives may be used in an amount of greater than 0 to about 5% by weight, such as about 0.1 to about 2% by weight.

Fillers contemplated for optional use include, for example, aluminum nitride, boron nitride, silicon carbide, diamond, graphite, beryllium oxide, magnesia, titanium oxide, silicas, such as fumed silica or fused silica, alumina, perfluorinated hydrocarbon polymers (i.e., TEFLON), thermoplastic polymers, thermoplastic elastomers, mica, glass powder and the like. Preferably, the particle size of these fillers will be about 20 microns or less.

As regards silicas, the silica may have a mean particle diameter on the nanoparticle size; that is, having a mean particle diameter on the order of 10-9 meters. The silica nanoparticles can be pre-dispersed in epoxy resins and may be selected from those available under the tradename NANOPOX, from Nanoresins, Germany. NANOPOX is a tradename for a product family of silica nanoparticle reinforced epoxy resins showing an outstanding combination of material properties. The silica phase consists of surface-modified, synthetic SiO: nanospheres with less than 50 nm diameter and an extremely narrow particle size distribution. The SiO nanospheres are agglomerate-free dispersions in the epoxy resin matrix resulting in a low viscosity for resins containing up to 50 wt % silica.

A commercially available example of the NANOPOX products particularly desirable for use herein includes NANOPOX A610 (a 40 percent by weight dispersion in a cycloaliphatic epoxy resin matrix). The NANOPOX products are believed to have a particle size of about 5 nm to about 80 nm, though the manufacturer reports less than 50 nm.

The silica component should be present in an amount in the range of about 1 to about 60 percent by weight, such as about 3 to about 30 percent by weight, desirably about 5 to about 20 percent by weight, based on the total weight of the composition.

Flexibilizers (also called plasticizers) contemplated for use herein include branched polyalkanes or polysiloxanes that can lower the T_{g} of the composition. Such flexibilizers include, for example, polyethers, polyesters, polythiols, polysulfides, and the like. If used, flexibilizers typically are present in the range of about 0.5 weight percent up to about 30 weight percent of the composition.

The flexibilizers may also be reactive; that is, they may be functionalized so as to react into the cured reaction product. In such cases, hydroxyl-functionalized resins can be used, as they tend to co-react with cationically curable components, such as epoxy resins, and thus used can modify the mechanical properties of the cured products.

For instance, hydroxy-functionalized aliphatic polyester diols provide improved flexibility to the cured composition. One commercially available example of the diol is K-FLEX A307, which is from King Industries. K-FLEX A307 is reported by the manufacturer to be a low viscosity, 100% solids linear, saturated, aliphatic polyester diol with primary hydroxyl groups. K-FLEX A307 is promoted to have been designed as a flexibility modifier for acrylic/isocyanates and acrylic/melamine systems. Commercial applications are advertised as automotive OEM, automotive refinish, aerospace, industrial maintenance, and plastic coatings.

Others include PolyTHF 650/1400/2000/2900 (sold under the trade name TERATHANE), polycaprolactone diols and triols (Aldrich), polydimethylsiloxane-polycaprolactone diols (such as WAX 350 OH D from Wacker), K-PURE CDR-3441, CDR-3319 (King Industry), primary or secondary hydroxyl terminated polybutadienes/hydrogenated polybutadienes (Cray Valley, such as PolyBd/Krasol materials), and hydrogenated castor oils, such as THIXCIN R and THIXCIN E (Elementis Specialties), and the POLYCIN series (Vertellus Specialties Inc.). Other useful flexibilizers include polyurethane methacrylate capped resins and precursors to these materials, such as 3-methyl-5-pentanediol-adipic acid copolymer.

Tougheners contemplated for use particularly in the Part A composition include elastomeric polymers selected from elastomeric copolymers of a lower alkene monomer and (i) acrylic acid esters, (ii) methacrylic acid esters or (iii) vinyl acetate, such as acrylic rubbers; polyester urethanes; ethylene-vinyl acetates; fluorinated rubbers; isoprene-acrylonitrile polymers; chlorosulfinated polyethylenes; and homopolymers of polyvinyl acetate were found to be particularly useful. [See U.S. Pat. No. 4,440,910 (O'Connor), the disclosures of each of which are hereby expressly incorporated herein by reference.] The elastomeric polymers are described in the '910 patent as either homopolymers of alkyl esters of acrylic acid; copolymers of another polymerizable monomer, such as lower alkenes, with an alkyl or alkoxy ester of acrylic acid; and copolymers of alkyl or alkoxy esters of acrylic acid. Other unsaturated monomers which may be copolymerized with the alkyl and alkoxy esters of acrylic include dienes, reactive halogen-containing unsaturated compounds and other acrylic monomers such as acrylamides.

For instance, one group of such elastomeric polymers are copolymers of methyl acrylate and ethylene, manufactured by DuPont, under the name of VAMAC, such as VAMAC N123 and VAMAC B-124. VAMAC N123 and VAMAC B-124 are reported by DuPont to be a master batch of ethylene/acrylic elastomer. The DuPont material VAMAC G is a similar copolymer but contains no fillers to provide color or stabilizers. VAMAC VCS rubber appears to be the base rubber, from which the remaining members of the VAMAC product line are compounded. VAMAC VCS (also known as VAMAC MR) is a reaction product of the combination of ethylene, methyl acrylate and monomers having carboxylic acid cure sites, which once formed is then substantially free of processing aids such as the release agents octadecyl amine, complex organic phosphate esters and/or stearic acid, and anti-oxidants, such as substituted diphenyl amine.

Recently, DuPont has provided to the market under the trade designation VAMAC VMX 1012 and VCD 6200, which are rubbers made from ethylene and methyl acrylate. It is believed that the VAMAC VMX 1012 rubber possesses little to no carboxylic acid in the polymer backbone. Like the VAMAC VCS rubber, the VAMAC VMX 1012 and VCD 6200 rubbers are substantially free of processing aids such as the release agents octadecyl amine, complex organic phosphate esters and/or stearic acid, and anti-oxidants, such as substituted diphenyl amine, noted above. All of these VAMAC elastomeric polymers are useful herein.

In addition, vinylidene chloride-acrylonitrile copolymers [see U.S. Pat. No. 4,102,945 (Gleave)] and vinyl chloride/vinyl acetate copolymers [see U.S. Pat. No. 4,444,933 (Columbus)] may be included in the Part A composition. Of course, the disclosures of each these U.S. patents are hereby incorporated herein by reference in their entirety.

Copolymers of polyethylene and polyvinyl acetate, available commercially under the tradename LEVAMELT by LANXESS Limited, are useful.

A range of LEVAMELT agents is available and includes for example, LEVAMELT 400, LEVAMELT 600 and LEVAMELT 900. The LEVAMELT products differ in the amount of vinyl acetate present. For example, LEVAMELT 400 comprises an ethylene-vinyl acetate copolymer comprising 40 wt % vinyl acetate. The LEVAMELT-brand products are supplied in granular form. The granules are almost colourless and dusted with silica and talc. The LEVAMELT-brand products consist of methylene units forming a saturated main chain with pendant acetate groups. The presence of a fully saturated main chain is an indication that LEVAMELT is a particularly stable polymer. It does not contain any reactive double bonds which make conventional rubbers prone to aging reactions, ozone and UV light. The saturated backbone is reported to make it robust.

Interestingly, depending on the ratio of polyethylene/polyvinylacetate, the solubilities of these LEVAMELT elastomers change in different monomers and also the ability to toughen changes as a result of the solubility.

The LEVAMELT elastomers are available in pellet form and are easier to formulate than other known elastomeric toughening agents.

VINNOL brand surface coating resins available commercially from Wacker Chemie AG, Munich, Germany represent a broad range of vinyl chloride-derived copolymers and terpolymers that are promoted for use in different industrial applications. The main constituents of these polymers are different compositions of vinyl chloride and vinyl acetate. The terpolymers of the VINNOL product line additionally contain carboxyl or hydroxyl groups. These vinyl chloride/vinyl acetate copolymers and terpolymers may also be used.

VINNOL surface coating resins with carboxyl groups are terpolymers of vinyl chloride, vinyl acetate and dicarboxylic acids, varying in terms of their molar composition and degree and process of polymerization. These terpolymers are reported to show excellent adhesion, particularly on metallic substrates.

VINNOL surface coating resins with hydroxyl groups are copolymers and terpolymers of vinyl chloride, hydroxyacrylate and dicarboxylate, varying in terms of their composition and degree of polymerization.

VINNOL surface coating resins without functional groups are copolymers of vinyl chloride and vinyl acetate of variable molar composition and degree of polymerization.

Rubber particles, especially rubber particles that have relatively small average particle size (e.g., less than about 500 nm or less than about 200 nm), may also be included, particularly in the Part B composition. The rubber particles may or may not have a shell common to known core-shell structures. In the case of rubber particles having a core-shell structure, such particles generally have a core comprised of a polymeric material having elastomeric or rubbery properties (i.e., a glass transition temperature less than about 0° C., e.g., less than about −30° C.) surrounded by a shell comprised of a non-elastomeric polymeric material (i.e., a thermoplastic or thermoset/crosslinked polymer having a glass transition temperature greater than ambient temperatures, e.g., greater than about 50° C.). For example, the core may be comprised of a diene homopolymer or copolymer (for example, a homopolymer of butadiene or isoprene, a copolymer of butadiene or isoprene with one or more ethylenically unsaturated monomers such as vinyl aromatic monomers, (meth)acrylonitrile, (meth)acrylates, or the like) while the shell may be comprised of a polymer or copolymer of one or more monomers such as (meth)acrylates (e.g., methyl methacrylate), vinyl aromatic monomers (e.g., styrene), vinyl cyanides (e.g., acrylonitrile), unsaturated acids and anhydrides (e.g., acrylic acid), (meth)acrylamides, and the like having a suitably high glass transition temperature. Other rubbery polymers may also be suitably be used for the core, including polybutylacrylate or polysiloxane elastomer (e.g., polydimethylsiloxane, particularly crosslinked polydimethylsiloxane).

The rubber particle may be comprised of more than two layers (e.g., a central core of one rubbery material may be surrounded by a second core of a different rubbery material or the rubbery core may be surrounded by two shells of different composition or the rubber particle may have the structure soft core, hard shell, soft shell, hard shell). In one embodiment of the invention, the rubber particles used are comprised of a core and at least two concentric shells having different chemical compositions and/or properties. Either the core or the shell or both the core and the shell may be crosslinked (e.g., ionically or covalently). The shell may be grafted onto the core. The polymer comprising the shell may bear one or more different types of functional groups (e.g., epoxy groups) that are capable of interacting with other components of the compositions of the present invention.

Typically, the core will comprise from about 50 to about 95 weight percent of the rubber particles while the shell will comprise from about 5 to about 50 weight percent of the rubber particles.

Preferably, the rubber particles are relatively small in size. For example, the average particle size may be from about 0.03 to about 2 microns or from about 0.05 to about 1 micron. The rubber particles may have an average diameter of less than about 500 nm, such as less than about 200 nm. For example, the core-shell rubber particles may have an average diameter within the range of from about 25 to about 200 nm.

Methods of preparing rubber particles having a core-shell structure are well-known in the art and are described, for example, in U.S. Pat. Nos. 4,419,496, 4,778,851, 5,981,659, 6,111,015, 6,147,142 and 6,180,693, each of which being incorporated herein by reference in its entirety.

Rubber particles having a core-shell structure may be prepared as a masterbatch where the rubber particles are dispersed in one or more epoxy resins such as a diglycidyl ether of bisphenol A. For example, the rubber particles typically are prepared as aqueous dispersions or emulsions. Such dispersions or emulsions may be combined with the desired epoxy resin or mixture of epoxy resins and the water and other volatile substances removed by distillation or the like. One method of preparing such masterbatches is described in more detail in International Patent Publication No. WO 2004/108825, the disclosure of which being expressly incorporated herein by reference in its entirety. For example, an aqueous latex of rubber particles may be brought into contact with an organic medium having partial solubility in water and then with another organic medium having lower partial solubility in water than the first organic medium to separate the water and to provide a dispersion of the rubber particles in the second organic medium. This dispersion may then be mixed with the desired epoxy resin(s) and volatile substances removed by distillation or the like to provide the masterbatch.

Particularly suitable dispersions of rubber particles having a core-shell structure in an epoxy resin matrix are available from Kaneka Corporation.

For instance, the core may be formed predominantly from feed stocks of polybutadiene, polyacrylate, polybutadiene/acrylonitrile mixture, polyols and/or polysiloxanes or any other monomers that give a low glass transition temperature. The outer shells may be formed predominantly from feed stocks of polymethylmethacrylate, polystyrene or polyvinyl chloride or any other monomers that give a higher glass transition temperature.

The core shell rubbers may have a particle size in the range of 0.07 to 10 um, such as 0.1 to 5 um.

The core shell rubber made in this way may be dispersed in a thermosetting resin matrix, such as an epoxy matrix or a phenolic matrix. Examples of epoxy matrices include the diglycidyl ethers of bisphenol A, F or S, or biphenol, novalac epoxies, and cycloaliphatic epoxies. Examples of phenolic resins include bisphenol-A based phenoxies. The matrix material ordinarily is liquid at room temperature.

The core shell rubber dispersion may be present in an amount in the range of about 5 to about 50% by weight, with about 15 to about 25% by weight being desirable based on viscosity considerations.

When used, these core shell rubbers allow for toughening to occur in the composition and oftentimes in a predictable manner—in terms of temperature neutrality toward cure—because of the substantial uniform dispersion, which is ordinarily observed in the core shell rubbers as they are offered for sale commercially.

Many of the core-shell rubber structures available from Kaneka, such as those available under the KANEACE tradename, are believed to have a core made from a copolymer of (meth)acrylate-butadiene-styrene, where the butadiene is the primary component in the phase separated particles, dispersed in epoxy resins. Other commercially available masterbatches of core-shell rubber particles dispersed in epoxy resins include GENIOPERL M23A (a dispersion of 30 weight percent core-shell particles in an aromatic epoxy resin based on bisphenol A diglycidyl ether; the core-shell particles have an average diameter of ca. 100 nm and contain a crosslinked silicone elastomer core onto which an epoxy-functional acrylate copolymer has been grafted); the silicone elastomer core represents about 65 weight percent of the core-shell particle), available from Wacker Chemie GmbH.

In the case of those rubber particles that do not have such a shell, the rubber particles may be based on the core of such structures.

Preferably, the rubber particles are relatively small in size. For example, the average particle size may be from about 0.03 to about 2 μm or from about 0.05 to about 1 μm. In certain embodiments of the invention, the rubber particles have an average diameter of less than about 500 nm. In other embodiments, the average particle size is less than about 200 nm. For example, the rubber particles may have an average diameter within the range of from about 25 to about 200 nm or from about 50 to about 150 nm.

The rubber particles generally are comprised of a polymeric material having elastomeric or rubbery properties (i.e., a glass transition temperature less than about 0° C., e.g., less than about −30° C.). For example, the rubber particles may be comprised of a diene homopolymer or copolymer (for example, a homopolymer of butadiene or isoprene, a copolymer of butadiene or isoprene with one or more ethylenically unsaturated monomers such as vinyl aromatic monomers, (meth)acrylonitrile, (meth)acrylates, or the like) and polysiloxanes. The rubber particles may contain functional groups such as carboxylate groups, hydroxyl groups or the like and may have a linear, branched, crosslinked, random copolymer or block copolymer structure.

For instance, the rubber particles may be formed predominantly from feed stocks of dienes such as butadiene, (meth)acrylates, ethylenically unsaturated nitriles such as acrylonitrile, and/or any other monomers that when polymerized or copolymerized yield a polymer or copolymer having a low glass transition temperature.

The rubber particles may be used in a dry form or may be dispersed in a matrix, as noted above.

Typically, the composition may contain from about 5 to about 35 weight percent (in one embodiment, from about 15 to about 30 weight percent) rubber particles.

Combinations of different rubber particles may advantageously be used in the present invention. The rubber particles may differ, for example, in particle size, the glass transition temperatures of their respective materials, whether, to what extent and by what the materials are functionalized, and whether and how their surfaces are treated.

A portion of the rubber particles may be supplied in the form of a masterbatch where the particles are stably dispersed in an epoxy resin matrix and another portion may be supplied to the adhesive composition in the form of a dry powder (i.e., without any epoxy resin or other matrix material). For example, the adhesive composition may be prepared using both a first type of rubber particles in dry powder form having an average particle diameter of from about 0.1 to about 0.5 μm and a second type of rubber particles stably dispersed in a matrix of liquid bisphenol A diglycidyl ether at a concentration of from about 5 to about 50 percent by weight having an average particle diameter of from about 25 to about 200 nm. The weight ratio of first type: second type rubber particles may be from about 1.5:1 to about 0.3:1, for example.

The chemical composition of the rubber particles may be essentially uniform throughout each particle. However, the outer surface of the particle may be modified by reaction with a coupling agent, oxidizing agent or the like so as to enhance the ability to disperse the rubber particles in the adhesive composition (e.g., reduce agglomeration of the rubber particles, reduce the tendency of the rubber particles to settle out of the adhesive composition). Modification of the rubber particle surface may also enhance the adhesion of the epoxy resin matrix to the rubber particles when the adhesive is cured. The rubber particles may alternatively be irradiated so as to change the extent of crosslinking of the polymer(s) constituting the rubber particles in different regions of the particle. For example, the rubber particles may be treated with gamma radiation such that the rubber is more highly crosslinked near the surface of the particle than in the center of the particle.

Rubber particles that are suitable for use in the present invention are available from commercial sources. For example, rubber particles supplied by Eliokem, Inc. may be used, such as NEP R0401 and NEP R401S (both based on acrylonitrile/butadiene copolymer); NEP R0501 (based on carboxylated acrylonitrile/butadiene copolymer; CAS No. 9010-81-5); NEP R0601A (based on hydroxy-terminated polydimethylsiloxane; CAS No. 70131-67-8); and NEP R0701 and NEP 0701S (based on butadiene/styrene/2-vinylpyridine copolymer; CAS No. 25053-48-9). Also, those available under the PARALOID tradename, such as PARALOID 2314, PARALOID 2300, and PARALOID 2600, from Dow Chemical Co., Philadelphia, PA, and those available under the STAPHYLOID tradename, such as STAPHYLOID AC-3832, from Ganz Chemical Co., Ltd., Osaka, Japan.

Rubber particles that have been treated with a reactive gas or other reagent to modify the outer surfaces of the particles by, for instance, creating polar groups (e.g., hydroxyl groups, carboxylic acid groups) on the particle surface, are also suitable for use in the present invention. Illustrative reactive gases include, for example, ozone, Cl₂, F₂, O₂, SO₃, and oxidative gases. Methods of surface modifying rubber particles using such reagents are known in the art and are described, for example, in U.S. Pat. Nos. 5,382,635; 5,506,283; 5,693, 714; and 5,969,053, each of which is incorporated herein by reference in its entirety. Suitable surface modified rubber particles are also available from commercial sources, such as the rubbers sold under the tradename VISTAMER by Exousia Corporation.

Where the rubber particles are initially provided in dry form, it may be advantageous to ensure that such particles are well dispersed in the adhesive composition prior to curing the adhesive composition. That is, agglomerates of the rubber particles are preferably broken up so as to provide discrete individual rubber particles, which may be accomplished by intimate and thorough mixing of the dry rubber particles with other components of the adhesive composition. For example, dry rubber particles may be blended with epoxy resin and milled or melt compounded for a length of time effective to essentially completely disperse the rubber particles and break up any agglomerations of the rubber particles.

In addition, Nanoresins offers commercially products under the tradenames ALBIDUR (epoxy resins containing core shell silicone rubber particles; such as EP 2240, EP2240A, EP 5340); ALBIFLEX (epoxy-siloxane block copolymer resins); and ALBIPOX (epoxy resins containing epoxy-nitrile butadiene rubber adducts). A number of these types of tougheners can also be useful in the B part of the composition. An example of one of these core shell rubber particles is available commercially from Chemtura Corporation, Middlebury, CT under the tradename BLENDEX. In particular, BLENDEX 338 which is an ultra-high rubber ABS impact modifier based on a polybutadiene rubber.

Thickeners or viscosity modifiers are also useful. Useful materials in this regard include polyvinyl butyral resins sold under the tradename MOWITAL (Kuraray Ltd) such as Mowital B30T, B60T, B20H, B30H, B45H, B60H, B30HH and B60HH.

Other additives may also be included in the Part A composition. For instance, phosphoric acid may be included in the Part A composition. When included at levels in the range of about 50 ppm to about 1,000 ppm, such as about 100 to about 500 ppm, and applied to at least one aluminum substrate to be joined in a bonded assembly, improved strength and strength retention may be observed. More specifically, humidity, heat aging and solvent immersion testing show that the addition of phosphoric acid to the inventive two-part cyanoacrylate/cationically curable adhesive systems, may lead to dramatic improvements adhesive with excellent properties on both metals and plastics, particularly on aluminum durability.

In another aspect the invention relates to a method of bonding substrates that are underwater comprising:
applying, underwater, a cyanoacrylate composition to at least one substrate, wherein the cyanoacrylate composition comprises:
   a first part comprising a cyanoacrylate component and a cationic catalyst; and
   a second part comprising
      a cationically curable component, such as an epoxy component, an episulfide component, an oxetane component, and combinations thereof, and an initiator component, and
allowing the composition to cure underwater.

The cyanoacrylate composition may be applied wherein a ratio of the first part to second part of the cyanoacrylate composition in the range of about 1:1 to about 10:1, for example 2:1 or 3:1 or 4:1, or 5:1 or 6:1 or 7:1 or 8:1 or 9:1.

The cyanoacrylate composition may be applied in a ratio of the first part to second part of about a 1:1 ratio.

The method of bonding substrates that are underwater may comprise exposing the composition to water for up to 45 seconds prior to joining the surface of the second substrate with the coated surface of the first substrate. This may be referred to as the open time of the composition. The composition may have a good open time of up to 90 seconds, for example up to 60 seconds, for example up to 45 seconds. Beneficially a good open time allows time for the substrates to be correctly mated prior to the composition curing. The substrates can be assembled into an assembly in the correct configuration as the good open time allows time for assembly. The composition has a good open time and allows for nozzles (through which the composition is dispensed to be applied) to be changed underwater without the composition curing. The composition may form a film in the topmost layer of the film but does not cure in the bulk and has good open time.

In the method of bonding substrates that are underwater the composition does not mix with the water, for example in a water column, or otherwise disperse in water. The physical properties of the composition, for example its viscosity, are such that it does not mix with the water and stays where it is applied. The outermost layer of the composition may cure to form a film which prevents the bulk of the composition from coming into contact with the water. In this respect, cure through volume of the composition can occur later after two substrates are brought together.

The method of bonding substrates that are underwater may comprise curing the composition which can form a bond with a shear strength, as measured according to ASTM D1002, of at least of at least 0.2 N/mm² after curing for 24 hours, for example 0.4 N/mm² after curing for 168 hours. For example, when at least one substrate may comprise calcium carbonate, for example may be formed, wholly or partially, from calcium carbonate.

In the method of bonding substrates that are underwater curing the composition forms a bond with a shear strength, as measured according to ASTM D1002, of at least 0.2 N/mm² after curing for 24 hours, for example 0.4 N/mm² after curing for 168 hours. For example, when at least one substrate is formed from a metal, for example steel.

In the method of the invention one or both substrates may be naturally occurring and/or or man-made.

Naturally occurring substrates include coral substrates such as coral reefs. Coral reefs are formed by colonies of coral polyps. Calcium carbonate substrates may be bonded with the method of the present invention. These substrates include coral substrates such as calcium carbonate substrates including calcium carbonate skeletons of a coral substrate. For example, a method of the invention may be used to repair breakages in a coral formation and/or to add coral materials to a coral formation.

In the method of bonding substrates that are underwater one or both substrates may be a metal, for example wherein one or both substrates may be steel.

In the method of bonding substrates that are underwater at least one substrate may comprise a material selected from the group comprising: steel, aluminium, wood, fibreglass, a building material including aggregates, sand, concrete/cement materials including ferrocements, fibre-reinforced plastic.

Suitably, both substrates may independently comprise a material selected from the group comprising: steel, aluminium, wood, fibreglass, a building material including aggregates, sand, concrete/cement materials including ferrocements, fibre-reinforced plastic.

In the method of bonding substrates that are underwater at least one substrate may be a watercraft, such as a boat or a ship, or a part thereof. The method may be used for affixing items to boats or ships, for example fitting sensors or attaching replacement parts, or for performing repairs on boats or ships. With the method of the invention this can be carried out without needing to return to land to remove the boat or ship from the water.

In the method of bonding substrates that are underwater at least one substrate may be a structure which is located underwater or a part of a structure which extends underwater, such as a bridge, oil or gas rig apparatus, pipeline, dam, wind turbine or similar. Such structures cannot be removed from the water so it is beneficial to be able to be able to affix items, for example accessories, sensors or replacement parts, or to perform repairs while underwater.

In the method of bonding substrates that are underwater one or both substrates may comprise calcium carbonate, for example may be formed, wholly or partially, from calcium carbonate, for example wherein one or both substrates is a shell, for example wherein one or both substrates is a scleractinia shell.

In the method of bonding substrates that are underwater the nozzle life may be at least 4 minutes, for example at least 5 minutes. The dispense nozzles have good nozzle life because the composition does not prematurely cure and block the nozzle. This is surprising as compositions comprising cyanoacrylate typically experience fast cure when exposed to moisture, for example when they are underwater. Beneficially the nozzle life is increased and thus allows more of the composition to be applied before the nozzle has to be changed.

The method of bonding substrates that are underwater may be carried out in water containing varying amounts of salts and/or minerals. For example, the method may be carried out in distilled water or treated water such as in a public/mains water supply. The method may be carried out in freshwater such as in wells, rivers or lakes. The method may be carried out in saltwater, for example in seawater, for example in water having a salinity of from about 30 g/L to about 50 g/L.

The method of bonding substrates that are underwater may be carried out in water having a pH in the range of from about 6 to about 9, for example from about 6.5 to about 8 or from about 7.5 to about 8.5.

In another aspect the invention relates to an assembly comprising two underwater substrates that are bonded together by method of the invention.

### DETAILED DESCRIPTION

The method of bonding substrates that are underwater comprises applying, underwater a composition as disclosed herein to at least one substrate and allowing the composition to cure.

The nozzle life may be at least 4 minutes, for example at least 5 minutes. This means that the composition will not cure in this time in a nozzle which is used to dispense while the composition is being applied. It is possible that a thin layer of the composition may cure at a nozzle tip where the composition is in contact with the water. The bulk of the composition in a nozzle body which is not in contact with water will remain uncured. It will still be possible to dispense the composition from the nozzle as the composition has a good nozzle life underwater.

Beneficially the composition may be exposed to water for up to 45 seconds prior to joining the surface of the second substrate with the coated surface of the first substrate and the composition will remain uncured so that is possible to form a bond between the substrates.

The method comprises curing the composition underwater. The composition is not removed from water to cure. When cured the bond formed is strong. When cured the bond formed retains its strength over time making the method of the invention suitable for bonding substrates for long periods of time. The bond may have a shear strength, as measured according to ASTM D1002, of at least 0.2 N/mm² after curing for 24 hours, for example 0.4 N/mm² after curing for 168 hours. It is possible to achieve this bond strength with difficult to bond materials such as calcium carbonate. Beneficially bonding calcium carbonate for long periods of time, for example 168 hours, makes the method suitable for applications in coral reefs, for example for coral transplantation. The strength of the bond achieved may be greater than the failure point of the calcium carbonate which means that the calcium carbonate will break before the bond breaks. The bond may have a shear strength, as measured according to ASTM D1002, of at least of at least 0.2 N/mm² after curing for 24 hours, for example 0.4 N/mm² after curing for 168 hours. It is possible to achieve bonds with higher shear strengths on substrates with higher shear strengths as the substrate will not fail before the bond fails. For example, metals, for example steels, for example grit blasted mild steel (GBMS) have higher shear strengths than the bond formed by the method and may have a shear strength, as measured according to ASTM D1002, of at least 0.2 N/mm² after curing for 24 hours, for example 0.4 N/mm² after curing for 168 hours.

### Examples

In brief the bonding of the substrates to be tested was performed as follows. The substrates were submerged in water, such that the water was in contact with all surfaces of the substrates. The substrates were fully submerged. The substrates were not removed from the water prior to application of the adhesive.

The components of representative compositions of the invention and numbered 1 to 5 are specified in Table 1. Each column gives the amount in weight percent of each component for each of 5 compositions.

TABLE 1

| | Amounts (Wt %) | | | | |
|---|---|---|---|---|---|
| Component | 1 | 2 | 3 | 4 | 5 |

Part A

| | | | | | |
|---|---|---|---|---|---|
| Ethyl CA | 78.1 | 78.1 | 78.1 | 78.1 | 78.1 |
| Thickener | 20 | 20 | 20 | 20 | 20 |
| BF3* (ppm) | 10 | 10 | 10 | 10 | 10 |
| Phosphoric | 0.045 | 0.045 | 0.045 | 0.045 | 0.045 |
| Acid | | | | | |
| Cationic | 0.98 | 0.98 | 0.98 | 0.98 | 0.98 |
| Catalyst | | | | | |

Part B

| | | | | | |
|---|---|---|---|---|---|
| CYRACURE | 99.9 | 99.8 | 99.7 | 99.6 | 99.5 |
| 6110 | | | | | |
| 3,5- | 0.1 | 0.2 | 0.3 | 0.4 | 0.5 |
| Dibro- | | | | | |
| mopyridine | | | | | |

*Added as a stock solution

The composition no. 3 having the components/amounts listed in the column in Table 1 above was dispensed (in a 1:1 mix ratio) from a container and applied to a first substrate. A second substrate was overlapped by one inch (2.54 cm) and the substrates were clamped together so that the adhesive cured to form a bond between the substrates. The amount of time between dispensation from the container and overlapping the second substrate is the open time. Both the application of the adhesive and curing of the adhesive were performed underwater. For testing dry substrates, the substrates were not placed underwater. The substrates were dry, that is free from surface moisture, both when the adhesive was applied and when the adhesive was cured. The shear strength of the bond was measured according to ASTM D1002.

The following substrates were tested: Grit-blasted mild steel (GBMS), calcium carbonate.

### Results

GBMS substrates were bonded with an open time of 0 seconds. That is the composition was applied to the substrates and the substrates were immediately joined together. The substrates were not removed from the water while the adhesive cured. The bond was cured while fully submerged underwater. The results are shown in Table 2. The strength achieved allows the bonded substrates to be handled without the bond breaking. After curing for 24 hours the bond strength was maintained as shown in Table 2. After curing for 168 hours the bond strength was maintained as shown in Table 2.

Calcium carbonate substrates were bonded with an open time of 0 seconds. The substrates were not removed from the water while the adhesive cured. The bond was cured while fully submerged underwater. The adhesive achieved a good handling strength after curing for 5 minutes as shown in Table 2. This strength allows the bonded substrates to be handled without the bond breaking. After curing for 24 hours the bond strength was maintained as shown in Table 2. After curing for 168 hours the bond strength was maintained as shown in Table 2.

TABLE 2

| | | Shear strength N/mm² | | | |
|---|---|---|---|---|---|
| | | GMBS | | Calcium carbonate | |
| | | Dry | | Dry | |
| Cure time | | substrates | Underwater | substrates | Underwater |
| 5 | minutes | 0.5 | 0.0 | 0.9 | 0.5 |
| 24 | hours | 7.5 | 0.2 | 0.9 | 0.2 |
| 168 | hours | 14.0 | 0.4 | 1.1 | 0.4 |

The nozzle life of the packaging of the adhesive underwater is greater than 5 minutes when the adhesive is dispensed every 2 minutes or less. Table 3 shows that the adhesive composition was easily dispensed and did not block the nozzle after 5 minutes. The adhesive composition was easily extruded from the nozzle at 0 minutes, that is, when the nozzle was first open to the water. After 1 minute of being open to the water the composition was easily extruded from the nozzle. The nozzle being underwater did not prevent the dispensing of the composition. After an additional minute underwater (2 minutes) the composition was easily dispensed from the nozzle. After an additional minute underwater (3 minutes) the composition was easily dispensed from the nozzle. After an additional 2 minutes underwater (5 minutes) the tip of the nozzle required cleaning as the surface of the composition had begun to cure. There was no bulk cure of the composition, only a thin layer of composition had begun to cure. The tip of the nozzle was cleaned to remove the cured layer and the composition was easily dispensed from the nozzle as no bulk cure had occurred.

TABLE 3

| Time (min) | Nozzle life |
|---|---|
| 0 | Easily dispensed |
| 1 | Easily dispensed |
| 2 | Easily dispensed |
| 3 | Easily dispensed |
| 5 | Tip cleaning |
| | needed, easily |
| | dispensed |

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A method of bonding substrates that are underwater comprising:
applying, underwater, a cyanoacrylate composition to at least one substrate, wherein the cyanoacrylate composition comprises:
(a) a first part comprising:
a cyanoacrylate component and a cationic catalyst; and
(b) a second part comprising:
a cationically curable component, such as an epoxy component, an episulfide component, an oxetane component, and combinations thereof, and
an initiator component, and
allowing the composition to cure underwater.

2. The method of claim 1 wherein the cyanoacrylate component of the cyanoacrylate composition is selected from materials within the structure H₂C═C(CN)—COOR, wherein R is selected from C₁₋₁₅ alkyl, C₂₋₁₅ alkoxyalkyl, C₃₋₁₅ cycloalkyl, C₂₋₁₅ alkenyl, C₆₋₁₅ aralkyl, C₅₋₁₅ aryl, C₃₋₁₅ allyl and C₁₋₁₅ haloalkyl groups, for example wherein the cyanoacrylate component comprises ethyl-2-cyanoacrylate.

3. The method of claim 1, wherein the cationic catalyst comprises salts of lithium and metals from Group II of the Periodic Table, and non-nucleophilic acids.

4. The method of claim 3, wherein the cationic catalyst is a non-nucleophilic acid having a pH of less than 1.0 when measured as a 10% by weight solution in water.

5. The method of claim 1, wherein the cationic catalyst is a member selected from the group consisting of fluoroboric, fluoroarsenic, fluoroantimonic and fluorophosphoric acids; lithium tetrafluoroborate, calcium di-tetrafluoroborate, magnesium di-tetrafluoroborate, lithium hexafluorophosphate, calcium di-hexafluorophosphate, magnesium di-hexafluorophosphate, lithium hexafluoroantimonate and lithium hexafluoroarsenate; lanthanide triflate salts, aryl iodonium salts, aryl sulfonium salts, lanthanum triflate, ytterbium triflate, trimethoxyboroxine, trimethoxyboroxine-aluminum acetyl acetonate, amine-boron trihalide complexes, quaternary ammonium salts, quaternary phosphonium salts, tri-aryl sulfonium salts, di-aryl iodonium salts, and diazonium salts; trialkoxyboroxine curing agents; and combinations thereof.

6. The method of claim 1, wherein the cationic curable component is selected from an epoxy component, an episulfide component, an oxetane component, a vinyl ether component and combinations thereof.

7. The method of claim 1, wherein the cationic curable component is an epoxy component selected from the group consisting of cycloaliphatic epoxy, aromatic epoxy, aliphatic epoxy and hydrogenated aromatic epoxy.

8. The method of claim 1, wherein cationic curable component is an epoxy component selected from the group consisting of epoxy-functionalized hydrogenated bisphenol-A, bisphenol-F, bisphenol-E, bisphenol-S and biphenyl.

9. The method of claim 1, wherein the first part further comprises phosphoric acid.

10. The method of claim 1, wherein second part further comprises at least one of a plasticizer, a filler and a toughener.

11. The method of claim 10, wherein the toughener is a member selected from the group consisting of (1) (a) reaction products of the combination of ethylene, methyl acrylate and monomers having carboxylic acid cure sites, (2) (b) dipolymers of ethylene and methyl acrylate, (3) combinations of (a) and (b), (4) vinylidene chloride-acrylonitrile copolymers, (5) and vinyl chloride/vinyl acetate copolymer, (6) copolymers of polyethylene and polyvinyl acetate, and combinations thereof.

12. The method of claim 1, wherein the first part and the second part are present in a ratio of about 1:1 by volume.

13. The method of claim 1, wherein the initiator component is a member selected from the group consisting of heterocycles, pyridines, benzothiazoles, toluidines, and phenolics.

14. The method of claim 1, wherein the initiator component is a member selected from the group consisting of 3,5-dibromopyridine, 3,5-dichloropyridine, N, N-dimethyl-p-toluidine, 2,2-dipyridyl disulphide, 5-chloro-2-methyl benzothiazole, 2-methyl-mercaptobenzothiazole, N, N-dihydroethyl-p-toluidine, t-butylbenzothiazole sulphonamide, 4-methyl-2,2-ditertiarybutylphenol and 4-methoxyphenol.

15. The method of claim 1, wherein one or both substrates is a metal.

16. The method of claim 1, wherein one or both substrates comprises calcium carbonate.

17. The method of claim 1, wherein the nozzle life is at least 4 minutes.

18. An assembly comprising two underwater substrates that are bonded together by the method according to claim 1.
